(19) United States
(12) Patent Application Publication
(10) Pub. No.: US 2023/0019194 A1
(43) Pub. Date: Jan. 19, 2023

(54) Deep Learning in a Virtual Reality Environment

(71) Applicant: Dell Products, L.P., Round Rock, TX (US)

(72) Inventors: Pulkit Rathi, Bhopal (IN); Ian Roche, Glanmire (IE); Daniel Barrett, Moore, OK (US)

(21) Appl. No.: 17/378,199

(22) Filed: Jul. 16, 2021

(51) Int. Cl. G06N 3/08; G06F 3/0484; G06F 3/0481; G06N 3/04

(52) U.S. Cl. CPC G06N 3/08; G06F 3/04845; G06F 3/04815; G06N 3/04; G06F 2203/04806; G06F 3/0486

(57) ABSTRACT

A system can initiate a training session for a neural network that comprises inputting first data to the neural network to facilitate training of the neural network, wherein use of the neural network increases an accuracy of performing a task associated with the neural network according to a defined accuracy criterion. The system can render a first visual representation of the neural network during the training session via a user interface associated with a virtual reality environment, and render a second visual representation of a possible unintended behavior of the neural network as a result of being trained based on the first data. The system can modify the neural network with respect to the second visual representation in the neural network of the possible unintended behavior in response to receiving second data indicative of a user input via the user interface, the modify resulting in a modified neural network.

### BACKGROUND

An artificial neural network (sometimes referred to as a neural network) can generally comprise a computer system comprised of nodes (sometimes referred to as neurons) and connections between those nodes. Nodes can generally be arranged in groups referred to as layers, and nodes of a layer can generally perform a same type of operation on their respective input. A node can take as input an output from another node or an input to the neural network as a whole. A neural network can be trained to perform certain operations, such as to identify a human face in an image.

A virtual reality environment can comprise a form of a computer user interface that presents a three-dimensional environment to a user. In some examples, a user can wear a headset comprising a display, and a view into a virtual reality environment can change based on the user moving his or her head. A user can manipulate a virtual reality environment, such as by using motion controllers that he or she holds in each hand.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can initiate a training session for a neural network, the training session comprising inputting first data to the neural network to facilitate training of the neural network, wherein use of the neural network increases an accuracy of performing a task associated with the neural network according to a defined accuracy criterion. The system can render a first visual representation of the neural network during the training session via a user interface associated with a virtual reality environment. The system can render a second visual representation of a possible unintended behavior of the neural network as a result of being trained based on the first data. The system can modify the neural network with respect to the second visual representation in the neural network of the possible unintended behavior in response to receiving second data indicative of a user input via the user interface, the modify resulting in a modified neural network.

An example method can comprise initiating, by a system comprising a processor, a training session for a neural network. The method can further comprise rendering, by the system, a first visual representation of the training session of the neural network in a user interface of a virtual reality environment. The system can further comprise rendering, by the system, a second visual representation of a possible unintended behavior of the neural network processing input data in the training session. The system can further comprise modifying, by the system, the neural network with respect to the second visual representation in the neural network of the possible unintended behavior in response to receiving data indicative of a user input at the user interface of the virtual reality environment, the modify resulting in a modified neural network.

An example non-transitory computer-readable medium can comprise instructions that, in response to execution, cause a system comprising a processor to perform operations. These operations can comprise rendering, via a user interface of a virtual reality environment, a first visual representation of a neural network. The operations can further comprise rendering, via the user interface, a second visual representation of a possible unintended behavior of the neural network processing input data. The operations can further comprise modifying the neural network with respect to the second visual representation in the neural network of the possible unintended behavior in response to receiving data indicative of an instruction via the user interface of the virtual reality environment, the modify resulting in a modified neural network.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate deep learning in a virtual reality environment, in accordance with an embodiment of this disclosure;

FIG. 2 illustrates an example neural network that can be displayed in a virtual reality environment to facilitate deep learning in a virtual reality environment, in accordance with an embodiment of this disclosure;

FIG. 3 illustrates an example user interface of an initial start view of a neural network displayed in a virtual reality environment to facilitate deep learning in a virtual reality environment, in accordance with an embodiment of this disclosure;

FIG. 4 illustrates an example user interface of a training view of a neural network displayed in a virtual reality environment that shows forward propagation and back propagation to facilitate deep learning in a virtual reality environment, in accordance with an embodiment of this disclosure;

FIG. 5 illustrates an example user interface of a zoomed-in view of a layer of neural network displayed in a virtual reality environment to facilitate deep learning in a virtual reality environment, in accordance with an embodiment of this disclosure;

FIG. 6 illustrates an example user interface of a zoomed-in view of a neuron of neural network displayed in a virtual reality environment to facilitate deep learning in a virtual reality environment, in accordance with an embodiment of this disclosure;

FIG. 7 illustrates an example user interface of a view of connected neurons of neural network displayed in a virtual reality environment to facilitate deep learning in a virtual reality environment, in accordance with an embodiment of this disclosure;

FIG. 8 illustrates an example user interface of a neural network in a zoomed-in form, with an accompanying activation map, that can be displayed in a virtual reality environment to facilitate deep learning in a virtual reality environment, in accordance with an embodiment of this disclosure;

FIG. 9 illustrates an example sigmoid function, for which a representation can be displayed in a virtual reality environment to facilitate deep learning in a virtual reality environment, in accordance with an embodiment of this disclosure;

FIG. 10 illustrates an example ReLU function, for which a representation can be displayed in a virtual reality environment to facilitate deep learning in a virtual reality environment, in accordance with an embodiment of this disclosure;

FIG. 11 illustrates an example process flow for performing deep learning in a virtual reality environment, in accordance with an embodiment of this disclosure;

FIG. 12 illustrates another example process flow for performing deep learning in a virtual reality environment, in accordance with an embodiment of this disclosure;

FIG. 13 illustrates another example process flow for performing deep learning in a virtual reality environment pricing, in accordance with an embodiment of this disclosure;

FIG. 14 illustrates an example block diagram of a computer operable to execute an embodiment of this disclosure.

### DETAILED DESCRIPTION

### Overview

The present techniques can be implemented to visualize, develop, and debug artificial neural networks using virtual reality (VR).

Due to its complexity, an artificial neural network can appear to a user to be a black box, whose exact working is mysterious, making it difficult to debug issues with the neural network. Additionally, it can require great technical expertise to develop a complex neural network.

The present techniques can mitigate against these problems with developing neural network models. Using the present techniques, a person with basic knowledge of neural networks can develop complex deep networks that comprise a dense layer, a convolution layer, a pooling layer, and recurrent nodes using a drag-and-drop user interface provided within a virtual reality environment.

A system according to the present techniques can operate as follows. A user can load a neural network into a virtual reality environment and modify the neural network, or create a neural network within a virtual reality environment by moving multiple types of neural network layers within the virtual reality environment. Pre-trained neural network models can be provided for transfer learning, with an option to freeze or unfreeze each layer of a model.

Visualizations that indicate aspects of a neural network model can be made within a virtual reality environment. Changes in weights and biases for individual nodes can be visually indicated during a forward pass of a neural network model. Gradients can be visually indicated during backpropagation to identify both vanishing gradients and exploding gradients. Activation maps can be visually indicated for each filter, changes in activation maps can be monitored, and a predicted output can be indicated with a change in input.

A virtual reality-based development and visualization environment for an artificial neural network can assist in debugging the neural network as well as understanding how the neural network model functions in an immersive way. Prior approaches to neural networks using virtual reality techniques have been directed to creating a deep learning model, and not for debugging. Through the present techniques, a greater understanding of a neural network model can be achieved through a virtual reality environment.

A deep neural network can generally comprise a network comprising multiple layers of neurons stacked above each other. A deep neural network can act as a complex model that maps an input to an output. Weights and biases can comprise learnable parameters of a machine learning model.

A weight can generally comprise a scaling of an input value. A bias can comprise a value that is provided to a neuron regardless of the values of the inputs. When inputs are transmitted between neurons, weights can be applied to those inputs, along with the bias. A bias unit can guarantee that, even when all inputs are zero values, there will still be a nonzero value passed to the neuron to activate the neuron. This can be expressed as:

Y=Σ(weight*input)+bias

A neural network model can comprise a variety of layers. A dense layer can comprise a simple neuron, where each neuron of the layer is connected to all neurons in a previous layer. A convolution layer can perform a convolution operation on an input with a filter matrix or kernel. An output from a convolution of kernel and input matrix can be referred to as a feature map (a feature map can sometimes be referred to as an “activation map”).

A filter can be part of a convolution layer. When inputs are passed to filters, filters can produce a feature map as output. Multiple filters can be combined into one convolution layer.

A feature map can comprise the output activations for a given filter. A feature map can aid in debugging a neural network.

A pooling layer can be utilized to reduce a special size of an input to reduce an amount of computation involved with training the neural network. As a number of parameters increases in a model, the training time can also increase. To mitigate against this issue of increased training time, pooling layers can be used. There can be multiple types of pooling layers. Types of pooling layers include a max pooling layer, and an average pooling layer.

Virtual reality can comprise a computer-generated simulation in which a user can interact with an artificial, three-dimensional environment using electronic devices, such as special goggles. In some examples, a virtual reality technology permits a user to fully-interact with the virtual reality environment, to be effective. Virtual reality technology can involve specialized input and output devices for interaction with a virtual environment. Mounted headsets can be one such type of specialized device, as they can provide an immersive experience, and a view can be changed when a user moves his or her head. Input devices can include a wired glove or a three-dimensional mouse.

Previous techniques to leverage deep learning with virtual reality are limited in scope (e.g., limited to convolutional neural networks) and are focused on constructing a model.

The present techniques can be implemented to debug a neural network model by providing insight into specific gradients, and visualizations down to a neuron level. Furthermore, the present techniques support integrating existing models so that they can be debugged and visualized, without requiring that the model be built within a virtual reality environment. That is, a neural network can be visualized in a user-friendly way, which can make it easier to develop even a complex neural network model.

Neural networks can be considered to be a black box. It can be a difficult task to understand how a neural network works, and why a neural network made a certain decision. This can make debugging a neural network a difficult task. Visualizing the workings of a neural network in a virtual reality environment can aid with debugging.

Visualizing a neural network in a virtual reality environment can aid with identifying vanishing and exploding gradients. Problems with vanishing and exploding gradients can be more prominent in models with multiple layers.

Take a sigmoid function as an activation function in a neural network. During backpropagation, it can be that a maximum value of a sigmoid function is 0.25—e.g., when the output of the sigmoid function is 0.5. But, in some cases, a derivative can tend toward zero, which can greatly reduce a value of a gradient to be backpropagated. So, the gradient can be so small that it will not be able to update deeper layers of a model, which can increase training time.

Exploding gradients can be a problem where large error gradients accumulate, and result in large updates to a neural network model weights during training. If a model weights go to not-a-number (NaN) values during training, this can denote an exploding gradient problem. Exploding gradients can lead to an unstable model with bad results.

Visualizing a neural network in a virtual reality environment can aid with identifying dead neurons in a model. Dead neurons can occur based on a rectified linear unit (ReLU) activation function. If an input for a ReLU function is negative, then an output will be zero, and a derivative of the function will be zero. During backpropagation, due to a zero derivative, a gradient passed down can also be zero, so will not update a neuron value. Where a neuron's value is not updated, that neuron can be eliminated from a training process. Such a neuron can be referred to as a dead neuron.

Visualizing a neural network in a virtual reality environment can aid with understanding how a change in input affects an output prediction by visualizing feature maps. Feature maps can play a role in predicting when a convolution neural network is used. A feature map, or activation map, can represent output activations for a given filter. A reason for visualizing a feature map for a specific input image can be to try to gain an understanding of what features a convolution neural network detects.

A deep neural network can comprise a large number of layers, depending on an associated use case. Sometimes, due to a complex nature of a task, a complex neural network can be used. Writing code for a complex model can be a time-consuming task that requires human expertise. People who are not experts in a deep learning domain can find it difficult to create these models. The present techniques can provide for a drag-and-drop approach in virtual reality to make complex model development an easier task. The present techniques can also provide for reducing overall training times because of the assistance provided during an exploratory phase where a model can be thrown away, and then restarted from scratch.

The present techniques can be used to visualize weights and gradients of a model. Weights of a model can be visualized in a virtual reality environment, which can provide detail about the model. A user can see weights changing in real time during a training process. With each training, an example change in weights can be easily seen. In a similar manner, gradients can be visualized during backward propagation. These visualizations of gradients can be used to find exploding and vanishing gradients. Prior techniques do not provide for this level of granularity in debugging a model.

The present techniques can be used to visualize specific neurons in a model. Using virtual reality, a specific neuron can be zoomed into, and its behavior can be observed. Observing individual neurons can be useful in detecting dead neurons. Detecting dead neurons can be useful in speeding up a process of tuning a model.

The present techniques can be used to visualize feature maps to provide explainable artificial intelligence. Users can examine feature maps by expanding layers of a neural network model and selecting a feature map. An analysis of feature maps can indicate a working of a model. Changes in feature maps of a trained model can be examined by changing a test image pixel by pixel, and determining which feature maps are being activated by which pixels. These results can be displayed in real time.

The following examples can demonstrate a use case for the present techniques. An example provides for an easy debugging of a neural network model. Finding a reason for a wrong prediction by a neural network can be challenging. Visualization in a virtual reality environment can provide insights that can be used for debugging.

In an example, a user can design a neural network model architecture. The user can enter a virtual reality environment via a virtual reality headset. The user can initiate a training session for the neural network model. As training of the neural network progresses, the user can do several things to aid in debugging. The user can select a specific layer of the neural network model. The user can visualize a state of particular neurons or feature maps. The user can check for vanishing gradients (which can be indicated with a color in the virtual reality environment, such as red). The user can check for exploding gradients (which can be indicated with a color in the virtual reality environment, such as purple). The user can zoom out on the neural network model and observe a backpropagation process.

In another example, the present techniques can provide for a training platform for deep learning. A virtual reality environment according to the present techniques can be used as a training aid to learn about neural networks.

### Example Architectures

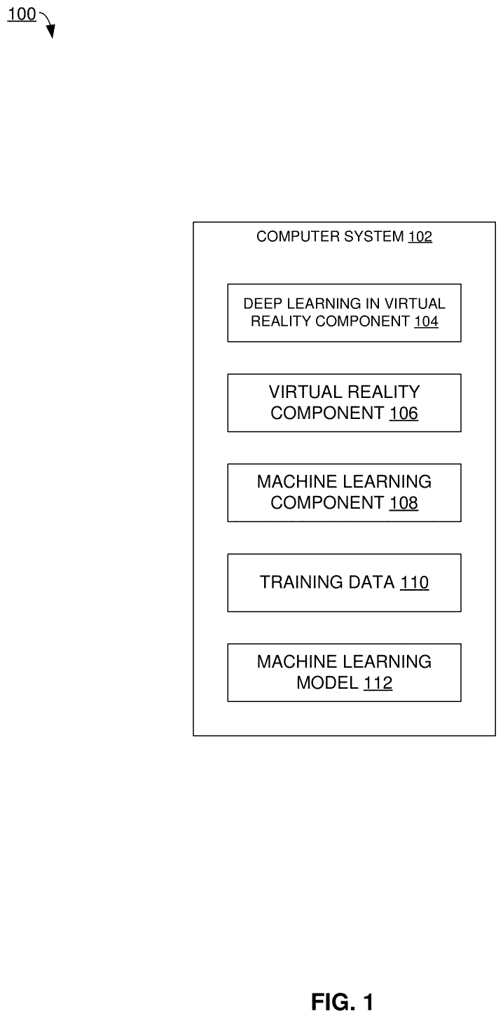

FIG. 1 illustrates an example system architecture 100 that can facilitate deep learning in a virtual reality environment, in accordance with an embodiment of this disclosure. System architecture 100 comprises computer system 102. In turn, computer system 102 comprises deep learning in virtual reality component 104, virtual reality component 106, machine learning component 108, machine learning model 110, and training data 112.

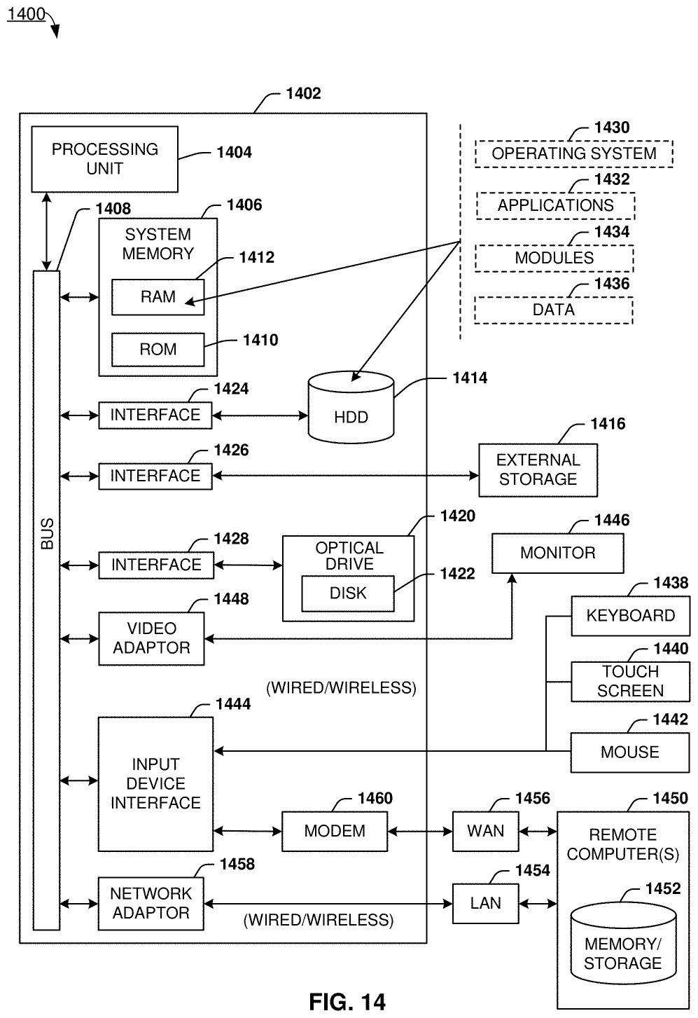

In some examples, computer system 102 can be implemented with one or more instances of computer 1402 of FIG. 14.

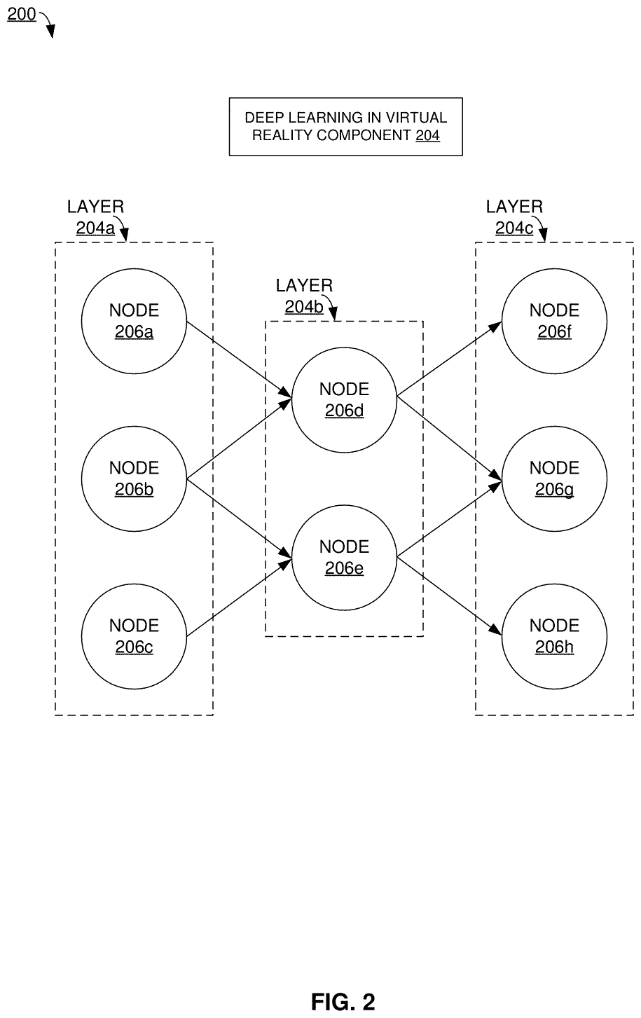

Deep learning in virtual reality component 104 can comprise a component that presents a machine learning model in a virtual reality environment, and processes user input to render different views of the machine learning model (e.g., zooming in or out) to aid in debugging the machine learning model. In the course of performing this role, deep learning in virtual reality component 104 can utilize machine learning model 110 (which can be a machine learning model that is rendered in the virtual reality environment, and which can be similar to parts of neural network 200 of FIG. 2) and training data 112 (which can comprise machine learning model training data that is used to train a machine learning model, such as machine learning model 110).

Virtual reality component 106 can be a component that creates and presents a virtual reality environment to a user, and that can be leveraged by deep learning in virtual reality component 104 to facilitate deep learning in a virtual reality environment. Machine learning component 108 can be a component that creates operates a machine learning model, and that can be leveraged by deep learning in virtual reality component 104 to facilitate deep learning in a virtual reality environment.

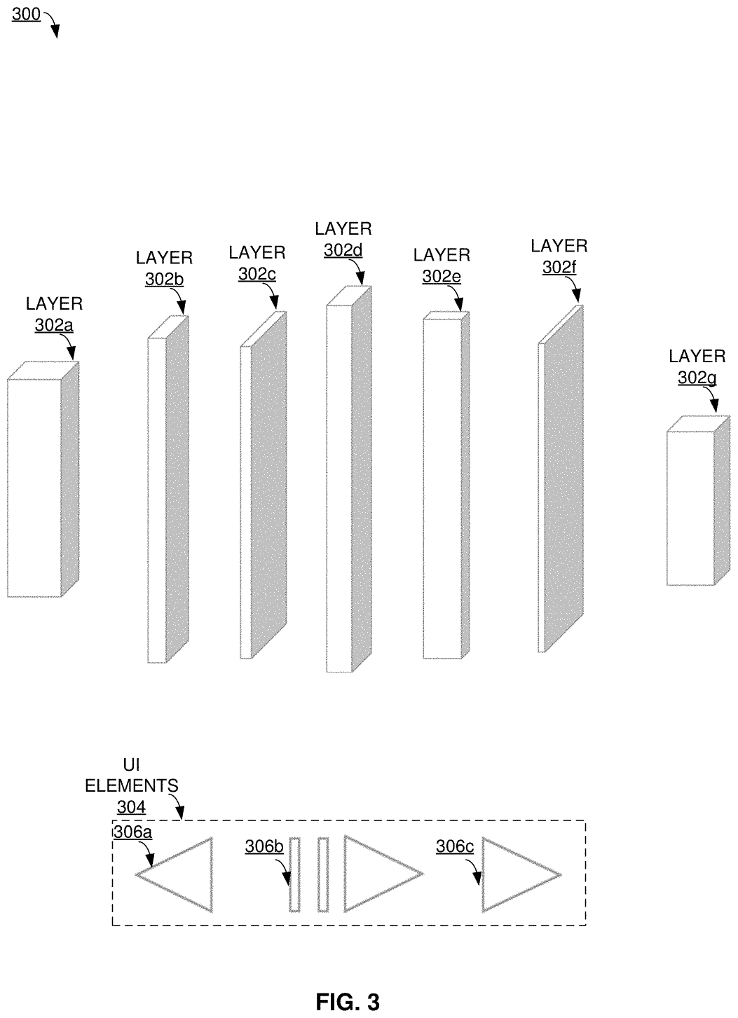

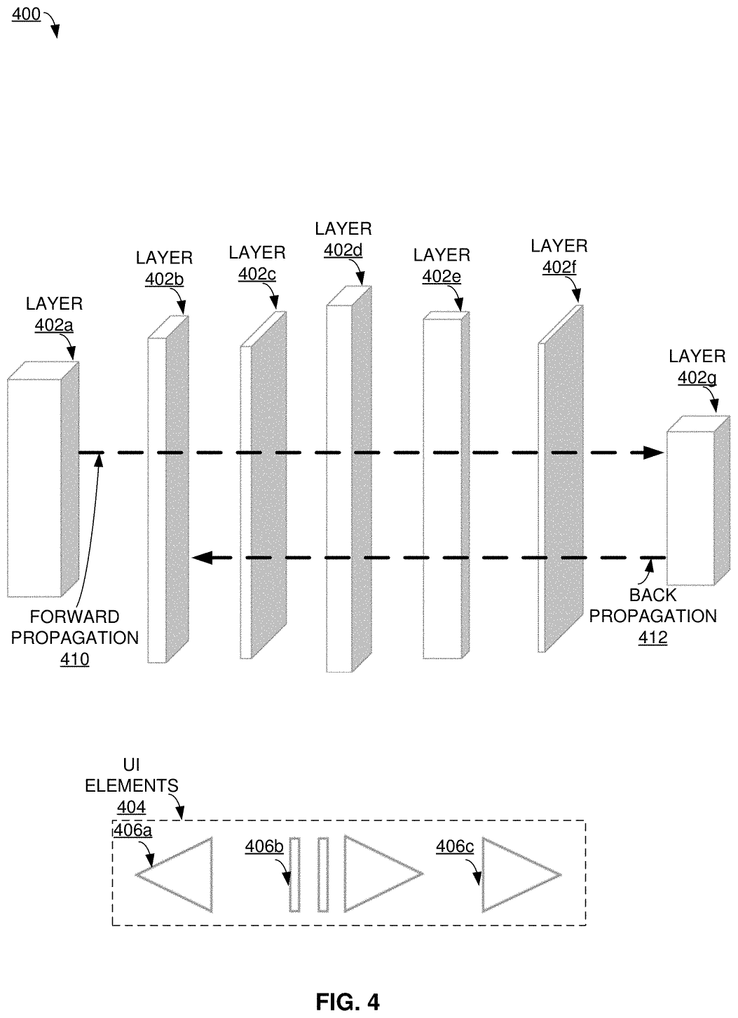

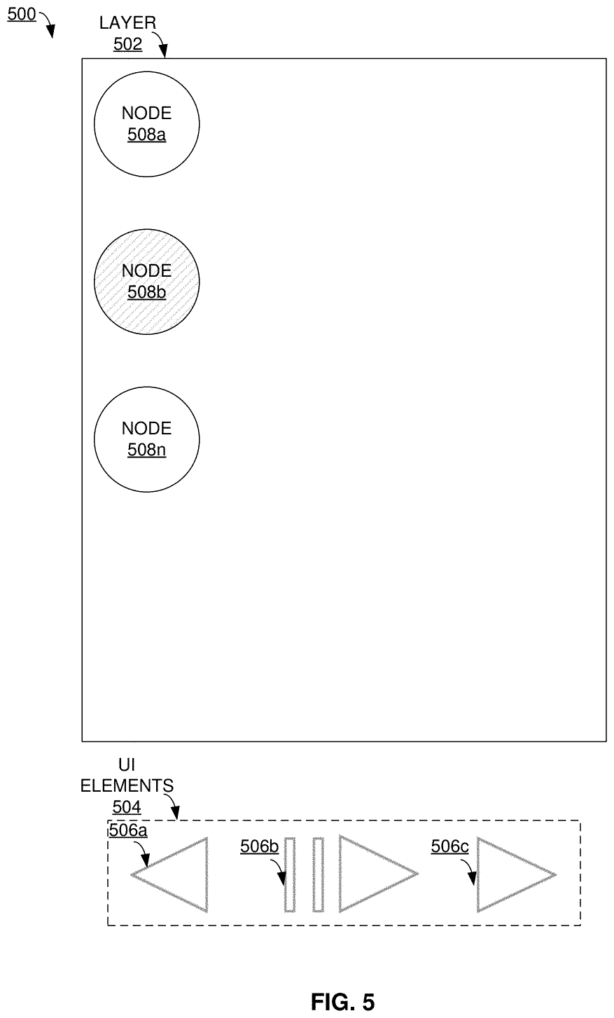

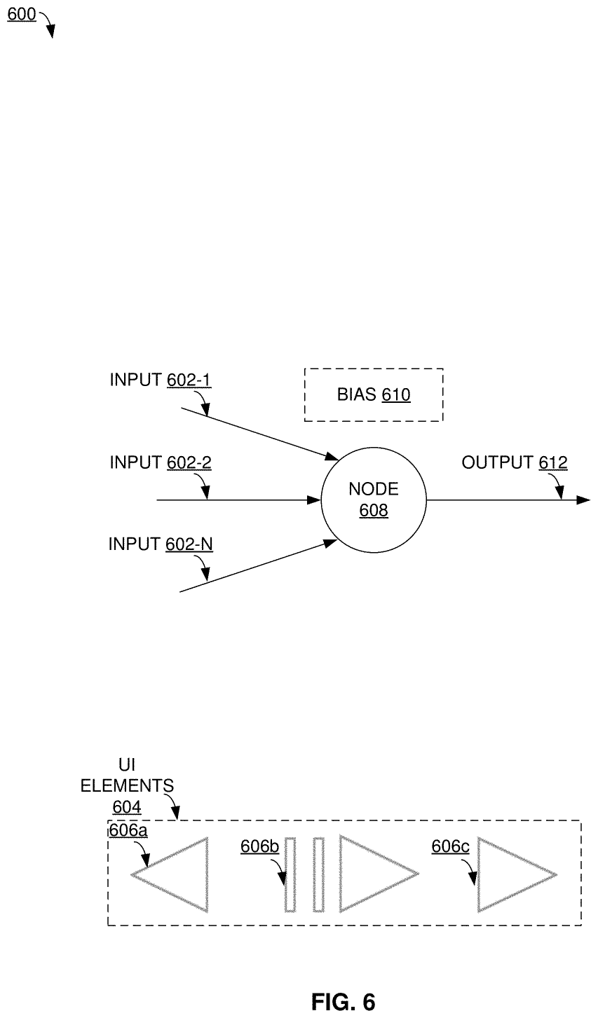

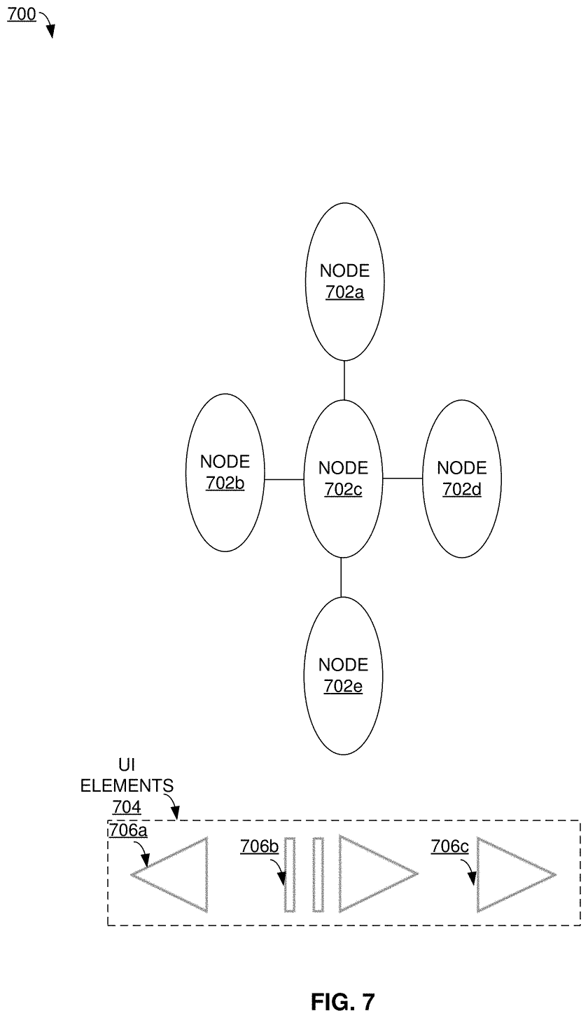

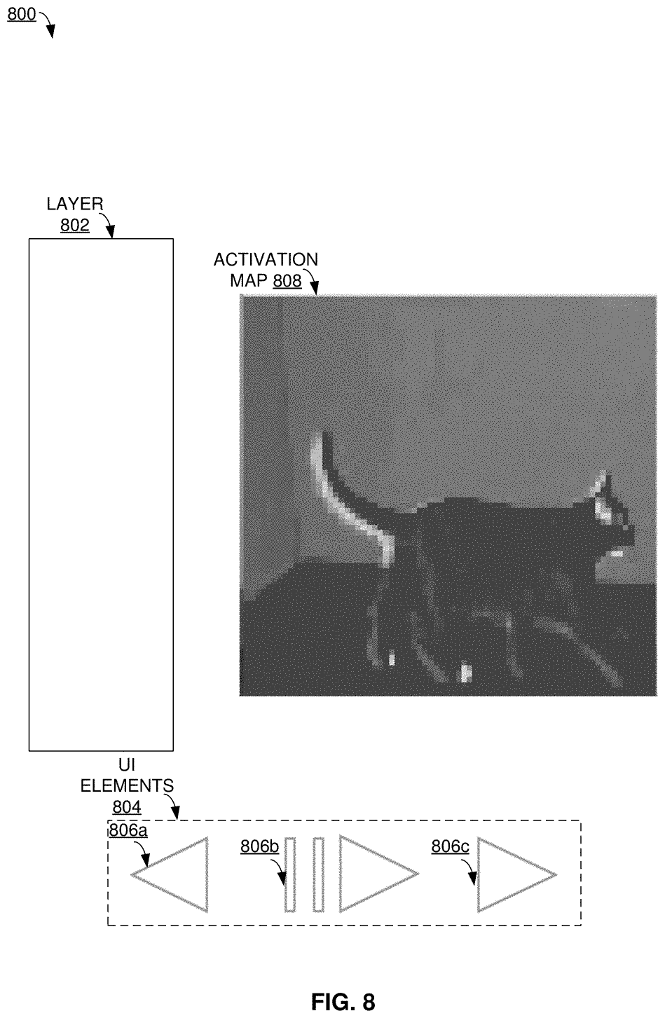

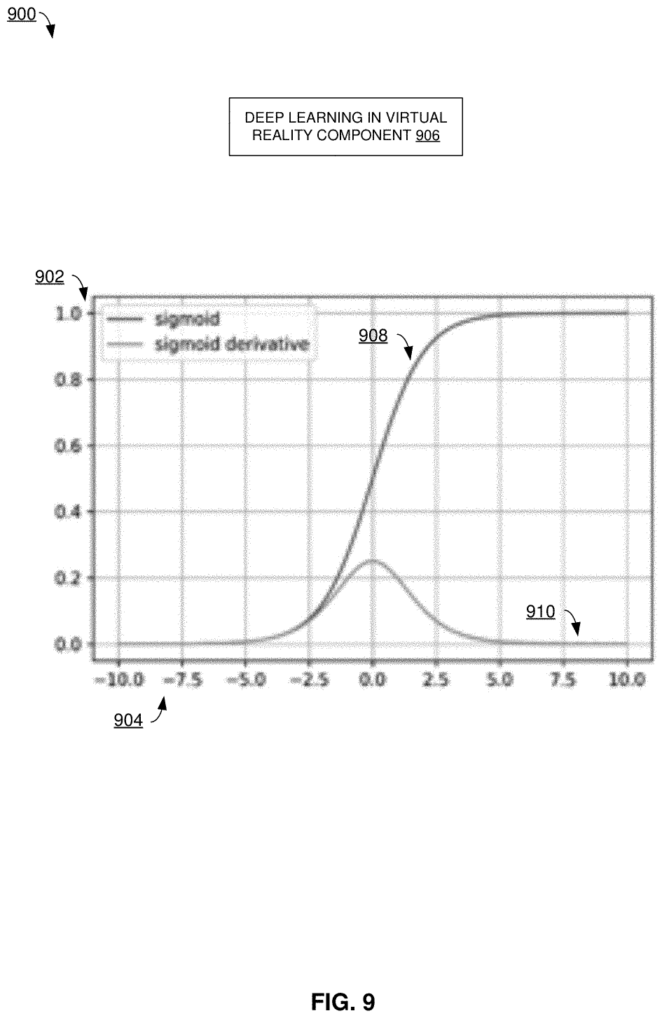

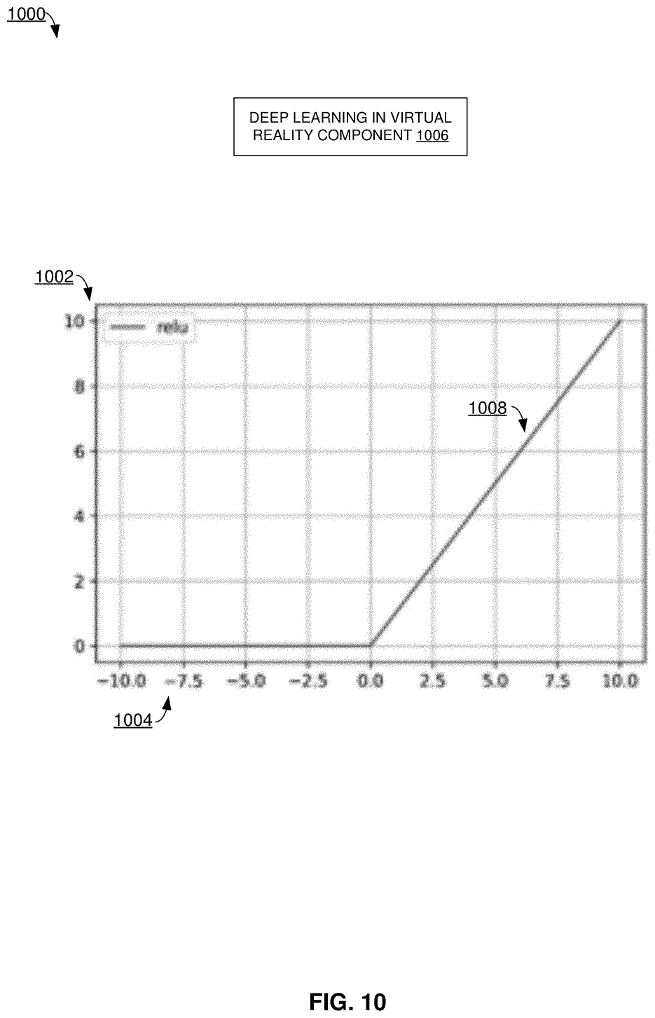

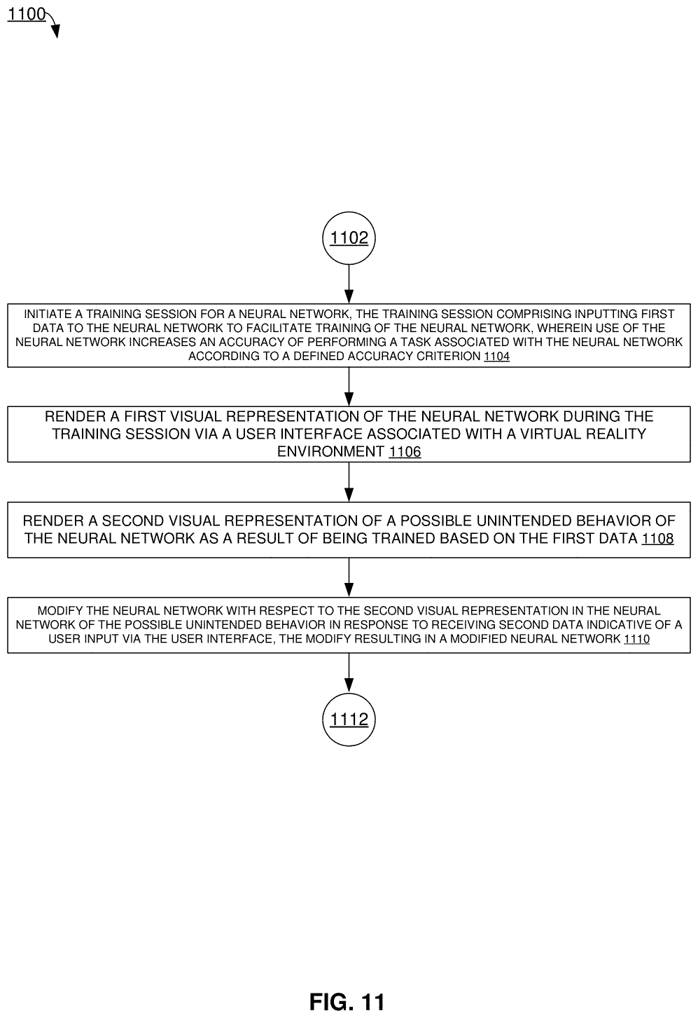

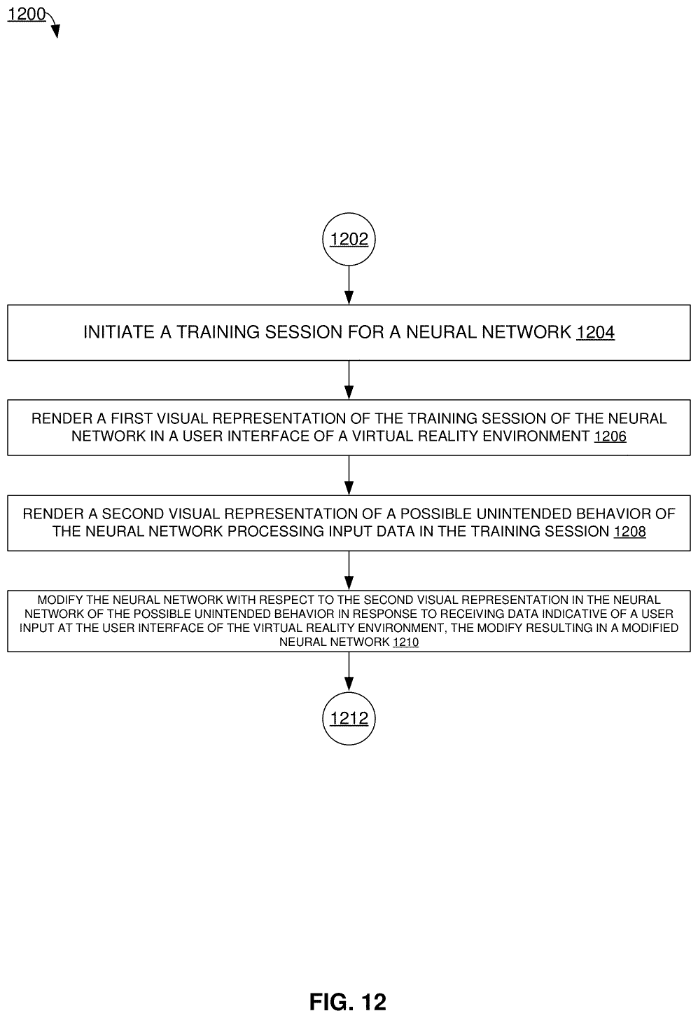

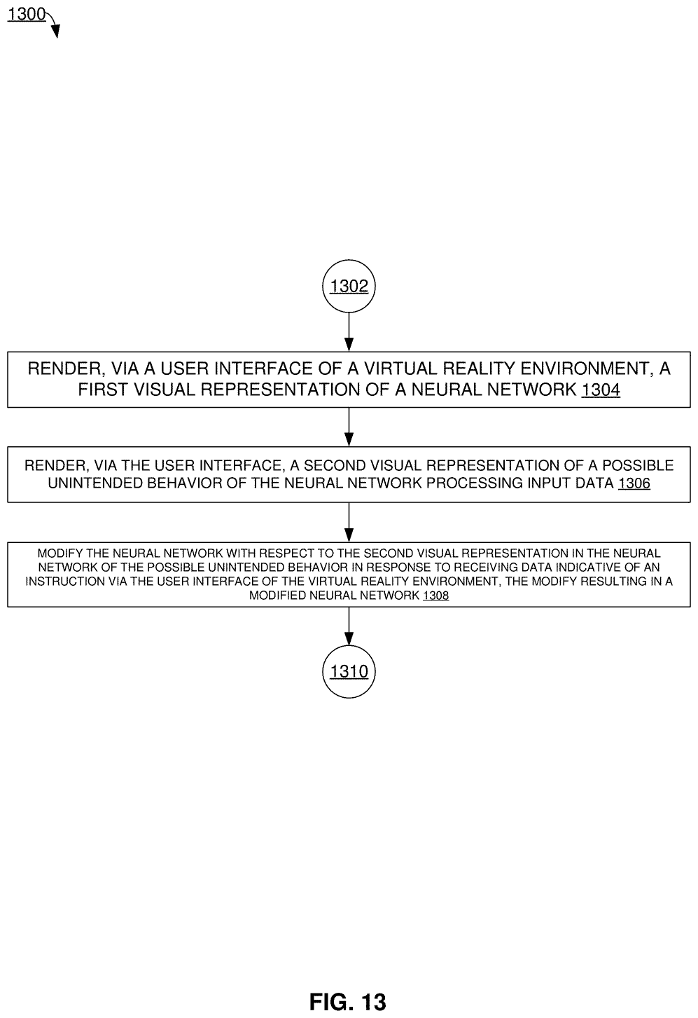

In the course of implementing deep learning in a virtual reality environment, deep learning in virtual reality component 104 can implement part(s) of process flow 1100 of FIG. 11, process flow 1200 of FIG. 12, and/or process flow 1300 of FIG. 13. Additionally, in the course of implementing deep learning in a virtual reality environment, deep learning in virtual reality component 104 can implement part(s) of user interface 300 of FIG. 3, user interface 400 of FIG. 4, user interface 500 of FIG. 5, user interface 600 of FIG. 6, user interface 700 of FIG. 7, and/or user interface 800 of FIG. 8. Furthermore, in the course of implementing deep learning in a virtual reality environment, deep learning in virtual reality component 104 can implement part(s) of sigmoid function 900 of FIG. 9 and/or RuLU function 1000 of FIG. 10.

FIG. 2 illustrates an example neural network 200 that can be displayed in a virtual reality environment to facilitate deep learning in a virtual reality environment, in accordance with an embodiment of this disclosure. In some examples, neural network 200 can be utilized by deep learning in virtual reality component 104 of FIG. 1 to facilitate deep learning in a virtual reality environment.

It can be appreciated that neural network 200 comprises a simplified neural network to illustrate parts of the present disclosure, and that the present techniques can be applied to neural networks with thousands of neurons, where identifying a bug and debugging the neural network can be a formidable task.

Neural network 200 comprises deep learning in virtual reality component 204 (which can be similar to deep learning in virtual reality component 104 of FIG. 1), layer 204a, layer 204b, and layer 204c. In turn, layer 204a comprises neuron 206a, neuron 206b, and neuron 206c; layer 204b comprises neuron 206d and neuron 206e; and layer 204c comprises neuron 206f, neuron 206g, and neuron 206h.

Layer 204a can comprise an input layer, layer 204b can comprise a hidden layer, and layer 204c can comprise an output layer. As an input layer, layer 204a can receive data input to a neural network, pass the input data through an activation function (e.g., sigmoid function 900 of FIG. 9 or ReLU function 1000 of FIG. 10), and pass those outputs (possibly with the addition of a respective bias) to the next layer—layer 204b.

As a hidden layer, layer 204b can be “hidden” because it is not exposed beyond the neural network itself—e.g., it is neither an input layer nor an output layer. Layer 204b can apply weights to its inputs (the outputs of layer 204a) and pass these inputs through an activation function, then pass those outputs (possibly with the addition of a respective bias) to the next layer—layer 204c.

As an output layer, layer 204c can receive inputs from layer 204b, apply weights to the and pass these inputs through an activation function, then output those outputs (possibly with the addition of a respective bias). In some examples, these outputs can be collected into one output value (e.g., an indication of whether an input image contains an image of a human face).

Each neuron (e.g., neuron 206a or neuron 206b) can perform a separate activation function, and apply its own weights and biases.

### Example User Interfaces

FIG. 3 illustrates an example user interface 300 of an initial start view of a neural network displayed in a virtual reality environment to facilitate deep learning in a virtual reality environment, in accordance with an embodiment of this disclosure. In some examples, parts of user interface 300 can be utilized by deep learning in virtual reality component 104 of FIG. 1 to facilitate deep learning in a virtual reality environment.

User interface 300 comprises layer 302a, layer 302b, layer 302c, layer 302d, layer 302e, layer 302f, and layer 302g (which can each be a layer of a neural network, such as machine learning model 110 of FIG. 1), and user interface elements 304 (which comprise step left element 306a, play/pause element 306b, and step right element 306c).

Each layer of user interface 300 comprises many neurons. Play/pause element 306b can be engaged to toggle between playing the neural network (e.g., having the neural network operate on training data) and pausing the neural network (e.g., having the neural network pause operating on training data at a particular point of operation). Step left element 306a can be engaged to move back through the operation of the training data (e.g., view a state of the neural network 1 second previously), and similarly, step right element 306c can be engaged to move forward through the operation of the training data (e.g., view a state of the neural network 1 second in the future, and pause there without continuing operation).

FIG. 4 illustrates an example user interface 400 of a training view of a neural network displayed in a virtual reality environment that shows forward propagation and back propagation to facilitate deep learning in a virtual reality environment, in accordance with an embodiment of this disclosure. In some examples, parts of user interface 400 can be utilized by deep learning in virtual reality component 104 of FIG. 1 to facilitate deep learning in a virtual reality environment.

User interface 400 comprises layer 402a, layer 402b, layer 402c, layer 402d, layer 402e, layer 402f, and layer 402g (which can be similar to layer 302a, layer 302b, layer 302c, layer 302d, layer 302e, layer 302f, and layer 302g of FIG. 3, respectively, which can each be a layer of a neural network, such as machine learning model 110 of FIG. 1), and user interface elements 404 (which can be similar to user interface elements 304 of FIG. 3, and which comprise step left element 406a, play/pause element 406b, and step right element 406c, which can be similar to step left element 306a, play/pause element 306b, and step right element 306c, respectively). In user interface 400, play/pause element 306b is engaged to play, so the model is being trained on training data.

User interface 400 also comprises forward propagation 410 and back propagation 412. Forward propagation 410 and back propagation 412 can give a visual indication of changes in the machine learning model (e.g., changes in weights and biases of neurons) that occur during training, and can specifically give a visual indication of parts of training that may be buggy—e.g., where there is an exploding gradient or a vanishing gradient.

FIG. 5 illustrates an example user interface 500 of a zoomed-in view of a layer of neural network displayed in a virtual reality environment to facilitate deep learning in a virtual reality environment, in accordance with an embodiment of this disclosure. In some examples, parts of user interface 500 can be utilized by deep learning in virtual reality component 104 of FIG. 1 to facilitate deep learning in a virtual reality environment.

User interface 500 can comprise a zoomed in version of the model of user interface 400 of FIG. 4, which is zoomed in to the level of one layer, and which shows neurons of that layer.

User interface 500 comprises layer 502 (which can be similar to layer 302b of FIG. 3), and user interface elements 504 (which can be similar to user interface elements 304 of FIG. 3, and which comprise step left element 506a, play/pause element 506b, and step right element 506c, which can be similar to step left element 306a, play/pause element 306b, and step right element 306c, respectively). In user interface 500, step right element 306c is engaged, so the model has stepped forward and then paused.

Layer 502 also comprises node 508a, node 508b, and node 508n. It can be appreciated that there can be layers with many more nodes, such as thousands of nodes. Here, node 508b is flagged by way of being presented differently visually to indicate that there is a possible gradient issue with the model that manifests itself at node 508b. A user in a virtual reality environment can see this and debug the model accordingly.

FIG. 6 illustrates an example user interface 600 of a zoomed-in view of a neuron of neural network displayed in a virtual reality environment to facilitate deep learning in a virtual reality environment, in accordance with an embodiment of this disclosure. In some examples, parts of user interface 600 can be utilized by deep learning in virtual reality component 104 of FIG. 1 to facilitate deep learning in a virtual reality environment.

User interface 600 can comprise a zoomed in version of the model of user interface 500 of FIG. 5, which is zoomed in to the level of one neuron 608 of layer 502.

User interface 600 comprises neuron 608, which has as inputs—input 602-a, input 602-2, and input 602-N—and bias 610, which neuron 608 uses to produce output 612 (such as via a ReLU function).

User interface 600 also comprises user interface elements 604 (which can be similar to user interface elements 304 of FIG. 3, and which comprise step left element 606a, play/pause element 606b, and step right element 606c, which can be similar to step left element 306a, play/pause element 306b, and step right element 306c, respectively). In user interface 600, the pause functionality of play/pause element 606b is engaged, so the model has been paused.

FIG. 7 illustrates an example user interface 700 of a view of connected neurons of neural network displayed in a virtual reality environment to facilitate deep learning in a virtual reality environment, in accordance with an embodiment of this disclosure. In some examples, parts of user interface 700 can be utilized by deep learning in virtual reality component 104 of FIG. 1 to facilitate deep learning in a virtual reality environment.

User interface 700 can comprise a zoomed in version of the model of user interface 300 of FIG. 3, which is zoomed in to the level of multiple connected neurons (neuron 702a, neuron 702b, neuron 702c, neuron 702d, and neuron 702e).

User interface 700 also comprises user interface elements 704 (which can be similar to user interface elements 304 of FIG. 3, and which comprise step left element 706a, play/pause element 706b, and step right element 706c, which can be similar to step left element 306a, play/pause element 306b, and step right element 306c, respectively). In user interface 700, the pause functionality of play/pause element 706b is engaged, so the model has been paused.

In user interface 700, a user engaging with the virtual reality environment can manipulate the environment to change a viewpoint to analyze different connected groups of neurons.

FIG. 8 illustrates an example user interface 800 of a neural network in a zoomed-in form, with an accompanying activation map, that can be displayed in a virtual reality environment to facilitate deep learning in a virtual reality environment, in accordance with an embodiment of this disclosure. In some examples, parts of user interface 800 can be utilized by deep learning in virtual reality component 104 of FIG. 1 to facilitate deep learning in a virtual reality environment.

User interface 800 can comprise a version of user interface 500 of FIG. 5, where the user has provided input indicative of showing an activation map that corresponds to layer 502.

User interface 800 comprises layer 802 (which can be similar to layer 500 of FIG. 5), and activation map 800, which can indicate an activation map of an input image to a neural network at the point of layer 802.

User interface 800 also comprises user interface elements 804 (which can be similar to user interface elements 304 of FIG. 3, and which comprise step left element 806a, play/pause element 806b, and step right element 806c, which can be similar to step left element 306a, play/pause element 306b, and step right element 306c, respectively). In user interface 800, the pause functionality of play/pause element 806b is engaged, so the model has been paused.

### Example Neuron Functions

FIG. 9 illustrates an example sigmoid function 900, for which a representation can be displayed in a virtual reality environment to facilitate deep learning in a virtual reality environment, in accordance with an embodiment of this disclosure. In some examples, parts of sigmoid function 900 can be utilized by deep learning in virtual reality component 104 of FIG. 1 to facilitate deep learning in a virtual reality environment.

Sigmoid function 900 comprises y-axis 902, x-axis 904, deep learning in virtual reality component 904 (which can be similar to deep learning in virtual reality component 104 of FIG. 1), sigmoid 908, and sigmoid derivative 910.

Sigmoid 908 can be expressed as:

Sigmoid(x)=1/(1+e^{-x})

Sigmoid derivative 910 can be expressed as:

Sigmoid′(x)=Sigmoid(x)*(1−Sigmoid(x))

Sigmoid 908 can be used as an activation function for a neuron of a model controlled by deep learning in virtual reality component 904. During backpropagation, a maximum value of sigmoid derivative 910 can be 0.25—e.g., when an output of sigmoid is 0.5. But, in some cases a value of sigmoid derivative 910 can tend to zero. When the value tends to zero, this can greatly reduce a value of a gradient to be backpropagated. The gradient can be so small that it does not lead to updating deeper layers of a model, which can increase model training time.

A virtual reality environment presented by sigmoid derivative deep learning in virtual reality component 904 can visually indicate this disappearing gradient issue to a user, so that the user can debug the neural network.

FIG. 10 illustrates an example ReLU function 1000, for which a representation can be displayed in a virtual reality environment to facilitate deep learning in a virtual reality environment, in accordance with an embodiment of this disclosure. In some examples, parts of ReLU function 1000 can be utilized by deep learning in virtual reality component 104 of FIG. 1 to facilitate deep learning in a virtual reality environment.

RuLU function 1000 comprises y-axis 1002, x-axis 1004, deep learning in virtual reality component 1004 (which can be similar to deep learning in virtual reality component 104 of FIG. 1), and ReLU 1008.

ReLU 1008 can be expressed as:

$$relu ( x ) = \{ \begin{matrix}x , & x > 0 \\ 0 , & x \leq 0\end{matrix}$$

A derivative of ReLU 1008 can be expressed as:

$${relu}^{′} ( x ) = \{ \begin{matrix}1 , & x > 0 \\ 0 , & x \leq 0\end{matrix}$$

In this example, where an input value to ReLU 908 is negative, then an output (as well as a derivative of ReLU 1008) is zero. During backpropagation, due to the derivative value of zero, a gradient passed down is zero, so the neuron value is not updated. This situation can essentially eliminate the neuron from the training process, and such a neuron can be referred to as a dead neuron.

A virtual reality environment presented by sigmoid derivative deep learning in virtual reality component 1004 can visually indicate this dead neuron issue to a user, so that the user can debug the neural network.

### Example Process Flows

FIG. 11 illustrates an example process flow 1100 for performing deep learning in a virtual reality environment, in accordance with an embodiment of this disclosure. In some examples, one or more embodiments of process flow 1100 can be implemented by deep learning in virtual reality component 104 of FIG. 1, or computing environment 1400 of FIG. 14.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 1200 of FIG. 12 and/or process flow 1300 of FIG. 13.

Process flow 1100 begins with 1102, and moves to operation 1104. Operation 1104 depicts initiating a training session for a neural network, the training session comprising inputting first data to the neural network to facilitate training of the neural network, wherein use of the neural network increases an accuracy of performing a task associated with the neural network according to a defined accuracy criterion. That is a training session for a neural network model can be initiated, where the neural network processes training data and uses it to update its model (e.g., its weights) to better perform a task (e.g., identify the presence of human faces in images).

After operation 1104, process flow 1100 moves to operation 1106.

Operation 1106 depicts rendering a first visual representation of the neural network during the training session via a user interface associated with a virtual reality environment. That is, and information about the training session can be experienced in a virtual reality environment.

After operation 1106, process flow 1100 moves to operation 1108.

Operation 1108 depicts rendering a second visual representation of a possible unintended behavior of the neural network as a result of being trained based on the first data. This can comprise, e.g., visually highlighting a dead neuron, or an exploding or vanishing gradient.

In some examples, operation 1108 comprises rendering a third visual representation of a change in a weight of an input to a neuron of the neural network. That is, how a weight changes can be shown.

In some examples, operation 1108 comprises rendering a third visual representation of a change in a value of an output of a neuron of the neural network. That is, how the neuron's output changes can be shown.

After operation 1108, process flow 1100 moves to operation 1110.

Operation 1110 depicts modifying the neural network with respect to the second visual representation in the neural network of the possible unintended behavior in response to receiving second data indicative of a user input via the user interface, the modifying resulting in a modified neural network. This can comprise debugging the neural network by modifying it to fix the issue identified in operation 1108.

In some examples, operation 1110 comprises moving a layer of the modified neural network from a first location within the modified neural network to a second location within the modified neural network in response to receiving third data indicative of a second user input at the user interface. That is, a user can use the virtual reality environment to move a layer of the neural network to a new position within the neural network.

In some examples, operation 1110 comprises changing a zoom level of the rendering of the first visual representation from a first zoom level to a second zoom level, wherein the second zoom level is a greater zoom than the first zoom level, wherein the second zoom level shows a detail of the neural network that is not shown at the first zoom level, and wherein the detail comprises an individual neuron of the neural network. That is, a user can manipulate the virtual reality environment to zoom in on the neural network to see individual neurons.

In some examples, operation 1110 comprises changing a zoom level of the rendering of the first visual representation from a first zoom level to a second zoom level, wherein the second zoom level is less than the first zoom level, wherein the second zoom level shows at least part of an overview of the neural network that is not shown at the first zoom level, and wherein at least the part of the overview comprises a back propagation of the neural network. That is, a user can manipulate the virtual reality environment to zoom out on the neural network to see a back propagation process occurring.

In some examples, operation 1110 comprises modifying a subset of an image represented by the first data, and rendering a third visual representation of a feature map that is activated based on the subset of the image. In some examples, portions of an input test image can be changed (e.g., one pixel at a time) to show which feature maps are activated by which pixels.

After operation 1110, process flow 1100 moves to 1112, where process flow 1100 ends.

FIG. 12 illustrates another example process flow 1200 for performing deep learning in a virtual reality environment, in accordance with an embodiment of this disclosure. In some examples, one or more embodiments of process flow 1200 can be implemented by deep learning in virtual reality component 104 of FIG. 1, or computing environment 1400 of FIG. 14.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 1100 of FIG. 11 and/or process flow 1300 of FIG. 13.

Process flow 1200 begins with 1202, and moves to operation 1204. Operation 1204 depicts initiating a training session for a neural network. In some examples, operation 1204 can be implemented in a similar manner as operation 1104 of FIG. 11.

After operation 1204, process flow 1200 moves to operation 1206.

Operation 1206 depicts rendering a first visual representation of the training session of the neural network in a user interface of a virtual reality environment. In some examples, operation 1206 can be implemented in a similar manner as operation 1106 of FIG. 11.

After operation 1206, process flow 1200 moves to operation 1208.

Operation 1208 depicts rendering a second visual representation of a possible unintended behavior of the neural network processing input data in the training session. In some examples, operation 1208 can be implemented in a similar manner as operation 1108 of FIG. 11.

In some examples, operation 1208 comprises rendering a third visual representation of a gradient during back-propagation of the neural network. That is, gradients and their status can be shown visually. In some examples, the third visual representation indicates that the gradient is vanishing. In some examples, the third visual representation indicates that the gradient is exploding. That is, vanishing gradients and exploding gradients can be highlighted to aid in debugging a neural network.

In some examples, operation 1208 comprises rendering a third visual representation of a first neuron of the neural network that is dead, the first neuron being visually represented in a different manner than a second neuron of the neural network that has a value that continues to be updated while executing the neural network. That is, a visual indication of a dead neuron can be shown, and used for debugging.

In some examples, where the data is a first data, the user input is a first user input, and the neural network comprises layers, and operation 1208 comprises, in response to receiving second data indicative of a second user input at the user interface of the virtual reality environment indicative of a zoom in operation, rendering, by the system, a third visual representation of a layer of the layers of the neural network. That is, the layers of a neural network can be expanded in response to a user manipulating a virtual reality environment.

In some examples, operation 1208 comprises, in response to receiving third data indicative of a third user input at the user interface of the virtual reality environment indicative of selecting a feature map that corresponds to the layer, rendering, by the system, a third visual representation of the feature map. That is, layers of a neural network can be shown, and a feature map for a layer or filter can be selected and shown.

After operation 1208, process flow 1200 moves to operation 1210.

Operation 1210 depicts modifying the neural network with respect to the second visual representation in the neural network of the possible unintended behavior in response to receiving data indicative of a user input at the user interface of the virtual reality environment, the modifying resulting in a modified neural network. In some examples, operation 1210 can be implemented in a similar manner as operation 1110 of FIG. 11.

After operation 1210, process flow 1200 moves to operation 1212.

FIG. 13 illustrates another example process flow 1300 for performing deep learning in a virtual reality environment pricing, in accordance with an embodiment of this disclosure. In some examples, one or more embodiments of process flow 1300 can be implemented by deep learning in virtual reality component 104 of FIG. 1, or computing environment 1400 of FIG. 14.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of one or more of process flow 1100 of FIG. 11 and/or process flow 1200 of FIG. 12.

Process flow 1300 begins with 1302, and moves to operation 1304.

Operation 1304 depicts rendering, via a user interface of a virtual reality environment, a first visual representation of a neural network. In some examples, operation 1304 can be implemented in a similar manner as operation 1106 of FIG. 11.

In some examples, operation 1304 comprises loading the neural network to be rendered via the user interface from a storage device, the neural network having been created outside of the virtual reality environment. That is, the neural network can be created outside of a virtual reality environment, and then imported into a virtual reality environment, or shown in a virtual reality environment, for debugging.

After operation 1304, process flow 1300 moves to operation 1306.

Operation 1306 depicts rendering, via the user interface, a second visual representation of a possible unintended behavior of the neural network processing input data. In some examples, operation 1306 can be implemented in a similar manner as operation 1108 of FIG. 11.

In some examples, operation 1306 comprises rendering, via the user interface, a third visual representation of an activation map of an image processed by the neural network, the activation map corresponding to a filter of the neural network. That is, a feature map can be rendered for a filter of the neural network.

In some examples, the activation map is a first activation map, the filter is a first filter, and operation 1306 comprises rendering, via the user interface, a third visual representation of a second activation map of the image processed by the neural network, the second activation map corresponding to a second filter of the neural network. That is, at varying points, each filter of a neural network can be selected to have its corresponding feature map shown.

In some examples, operation 1306 comprises displaying changes in activation maps of an image processed by the neural network. In some examples, operation 1306 comprises monitoring changes in a predicted output from the neural network with a change in input to the neural network. That is, changes in activation maps can be monitored (along with predicted output) along with a corresponding change in an input.

After operation 1306, process flow 1300 moves to operation 1308.

Operation 1308 depicts modifying the neural network with respect to the second visual representation in the neural network of the possible unintended behavior in response to receiving data indicative of an instruction via the user interface of the virtual reality environment, the modifying resulting in a modified neural network. In some examples, operation 1308 can be implemented in a similar manner as operation 1110 of FIG. 11.

After operation 1308, process flow 1300 moves to 1310, where process flow 1300 ends.

### Example Operating Environment

In order to provide additional context for various embodiments described herein, FIG. 14 and the following discussion are intended to provide a brief, general description of a suitable computing environment 1400 in which the various embodiments of the embodiment described herein can be implemented.

For example, parts of computing environment 1400 can be used to implement one or more embodiments of computer system 102 of FIG. 1.

In some examples, computing environment 1400 can implement one or more embodiments of the process flows of FIGS. 11-13 to facilitate deep learning in a virtual reality environment.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a nonvolatile storage such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enable with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
initiating a training session for a neural network, the training session comprising inputting first data to the neural network to facilitate training of the neural network, wherein use of the neural network increases an accuracy of performing a task associated with the neural network according to a defined accuracy criterion;
rendering a first visual representation of the neural network during the training session via a user interface associated with a virtual reality environment;
rendering a second visual representation of a possible unintended behavior of the neural network as a result of being trained based on the first data; and
modifying the neural network with respect to the second visual representation in the neural network of the possible unintended behavior in response to receiving second data indicative of a user input via the user interface, the modifying resulting in a modified neural network.

2. The system of claim 1, wherein the operations further comprise:
rendering a third visual representation of a change in a weight of an input to a neuron of the neural network.

3. The system of claim 1, wherein the operations further comprise:
rendering a third visual representation of a change in a value of an output of a neuron of the neural network.

4. The system of claim 1, wherein the user input is a first user input, and wherein the operations further comprise:
moving a layer of the modified neural network from a first location within the modified neural network to a second location within the modified neural network in response to receiving third data indicative of a second user input at the user interface.

5. The system of claim 1, wherein the operations further comprise:
changing a zoom level of the rendering of the first visual representation from a first zoom level to a second zoom level, wherein the second zoom level is a greater zoom than the first zoom level, wherein the second zoom level shows a detail of the neural network that is not shown at the first zoom level, and wherein the detail comprises an individual neuron of the neural network.

6. The system of claim 1, wherein the operations further comprise:
changing a zoom level of the rendering of the first visual representation from a first zoom level to a second zoom level, wherein the second zoom level is less than the first zoom level, wherein the second zoom level shows at least part of an overview of the neural network that is not shown at the first zoom level, and wherein at least the part of the overview comprises a back propagation of the neural network.

7. The system of claim 1, wherein the operations further comprise:
modifying a subset of an image represented by the first data; and
rendering a third visual representation of a feature map that is activated based on the subset of the image.

8. A method, comprising:
initiating, by a system comprising a processor, a training session for a neural network;
rendering, by the system, a first visual representation of the training session of the neural network in a user interface of a virtual reality environment;
rendering, by the system, a second visual representation of a possible unintended behavior of the neural network processing input data in the training session; and
modifying, by the system, the neural network with respect to the second visual representation in the neural network of the possible unintended behavior in response to receiving data indicative of a user input at the user interface of the virtual reality environment, the modifying resulting in a modified neural network.

9. The method of claim 8, further comprising:
rendering, by the system, a third visual representation of a gradient during back-propagation of the neural network.

10. The method of claim 9, wherein the third visual representation indicates that the gradient is vanishing.

11. The method of claim 9, wherein the third visual representation indicates that the gradient is exploding.

12. The method of claim 8, further comprising:
rendering, by the system, a third visual representation of a first neuron of the neural network that is dead, the first neuron being visually represented in a different manner than a second neuron of the neural network that has a value that continues to be updated while executing the neural network.

13. The method of claim 8, wherein the data is a first data, wherein the user input is a first user input, wherein the neural network comprises layers, and further comprising:
in response to receiving second data indicative of a second user input at the user interface of the virtual reality environment indicative of a zoom in operation, rendering, by the system, a third visual representation of a layer of the layers of the neural network.

14. The method of claim 13, further comprising:
in response to receiving third data indicative of a third user input at the user interface of the virtual reality environment indicative of selecting a feature map that corresponds to the layer, rendering, by the system, a third visual representation of the feature map.

15. A non-transitory computer-readable medium comprising instructions that, in response to execution, cause a system comprising a processor to perform operations, comprising:
rendering, via a user interface of a virtual reality environment, a first visual representation of a neural network;
rendering, via the user interface, a second visual representation of a possible unintended behavior of the neural network processing input data; and
modifying the neural network with respect to the second visual representation in the neural network of the possible unintended behavior in response to receiving data indicative of an instruction via the user interface of the virtual reality environment, the modifying resulting in a modified neural network.

16. The non-transitory computer-readable medium of claim 15, wherein the operations further comprise:
rendering, via the user interface, a third visual representation of an activation map of an image processed by the neural network, the activation map corresponding to a filter of the neural network.

17. The non-transitory computer-readable medium of claim 16, wherein the activation map is a first activation map, wherein the filter is a first filter, and wherein the operations further comprise:
rendering, via the user interface, a third visual representation of a second activation map of the image processed by the neural network, the second activation map corresponding to a second filter of the neural network.

18. The non-transitory computer-readable medium of claim 15, wherein the operations further comprise:
displaying changes in activation maps of an image processed by the neural network.

19. The non-transitory computer-readable medium of claim 15, wherein the operations further comprise:
monitoring changes in a predicted output from the neural network with a change in input to the neural network.

20. The non-transitory computer-readable medium of claim 15, wherein the operations further comprise:
loading the neural network to be rendered via the user interface from a storage device, the neural network having been created outside of the virtual reality environment.
